(19) United States
(12) Patent Application Publication
(10) Pub. No.: US 2006/0003117 A1
(43) Pub. Date: Jan. 5, 2006

(54) Ink jet recording paper

(75) Inventors: Annmarie Superka, Allentown, PA (US); Kevin Jay Roth, Bethlehem, PA (US)

Correspondence Address: Marvin J. powell;Minerals Technologies Inc., One Highland Avenue, Bethlehem, PA, 18017, US

(73) Assignee: Specialty Minerals (Michigan) Inc.

(21) Appl. No.: 10/867,535

(22) Filed: Jun. 14, 2004

(51) Int. Cl. D21H 19/38; B41M 5/50; C09C 1/02

(52) U.S. Cl. 428/32.37; 162/135; 162/181.2; 106/464; 428/330; 428/537.5

(57) ABSTRACT

A product and a process for the preparation of a precipitated calcium carbonate (PCC) and an ink jet recording paper, incorporating the precipitated calcium carbonate is disclosed. The precipitated calcium carbonate is dewatered and comminuted in the presence of an amphoteric and/or anionic dispersant to produce a high solids PCC composition. When used in coating formulations the PCC has a surface morphology and chemistry that enhances the printability of ink jet paper. Ink jet recording paper incorporating the PCC of the present teachings has reduced ink feathering and spreading as well as improved optical density, dry time, and water fastness.

### FIELD OF THE INVENTION

The present invention relates to milled and/or comminuted precipitated calcium carbonate (PCC) pigments for use in ink jet recording media. Additionally, the present invention relates to an ink jet recording paper that incorporates such pigments to impart enhanced print quality. The invention further relates to methods of producing PCC and to the application of such to ink jet recording paper.

The PCC particles produced according to the method of the present teachings are also useful as fillers in paper, pigment for coating formulations, as pigments for paints, as impact modifiers in polymers, as well as application in the food, nutrition, cosmetic and pharmaceutical industries.

### BACKGROUND OF THE INVENTION

Thermal ink jet processes apply dilute aqueous ink onto the surface of a paper by heating a small volume of the ink in a small chamber with an orifice that is directed at the recording paper. The small volume of ink that is heated rapidly reaches its boiling point, and the steam bubble formed propels a tiny drop of liquid ink at the paper, where the drop produces a single dot in a dot matrix that forms a character or image on the sheet. This process requires an ink that is low in solids and has low boiling point components so that it is capable of boiling rapidly without leaving a residue that can foul the heating element, and clog the orifice. Therefore, up to about 96 percent by weight of ink jet printer ink is a mixture of water and low molecular weight glycols. Although such ink boils quickly when heated to ensure rapid printing, and is not prone to clog, it results in an applied ink that is very mobile and slow to dry. Therefore, good print quality can be obtained only if the ink colorant or dye remains on or near the outer surface of the paper, and does not spread or move from the point at which it was applied.

It is also important that drying occurs rapidly to prevent smearing of the colorant. In printers that are not equipped with heating elements, the water and glycol components of the ink must penetrate into the body of the paper for proper drying of the colorant on the surface. If the colored phase is carried into the paper with the liquid phase as it penetrates into the paper, or if the colorant migrates across the surface of the paper, the quality of the resulting print or image will be poor. Also, dry ink colorant that is not permanently fixed on the paper will blot or run if the printed surface becomes wet or is marked with a highlighter. Therefore, the dry ink should have excellent water and highlighter fastness properties for optimum performance.

Multipurpose office papers generally provide inadequate or poor ink jet print quality. This is particularly true where multicolor printing with concomitant superimposed ink applications is utilized. The poor print quality is compounded in printers that apply the colors in one order when the print head moves to the right and the reverse order when the print head moves to the left. Multipurpose office papers often allow the colorant to penetrate into the paper, which results in reduced optical density of the printed image, and increased show through on the reverse side of the paper. Multipurpose office papers that are highly sized prevent liquid penetration, leading to higher ink optical density, but, also, excessive feathering (wicking of ink resulting in “fuzzy” images) and spreading (growth or widening of printed areas).

One method of improving ink jet print quality is to apply a material to the paper surface that binds the ink colorant to the surface, but allows the water/glycol liquid phase to pass into the body of the paper, which speeds drying. However, the ink colorant often is an unsaturated or aromatic organic compound, and if the surface material interacts too strongly with the colorant the color of the ink can change. Therefore, a surface material must be obtained that prevents the ink colorant from penetrating the paper, but does not interact so strongly as to effect the colorant, and cause a color change.

Other methods have used cationically charged pigments where it was thought these would be more interactive with ink jet dyes. However, these are usually low in solids concentration of from about 10 percent to about 20 percent, and therefore have application limitations, such as decreased production rates and/or lower coater speeds, due to the low solids concentration.

The current teachings provide for a pigment that when incorporated into a coating formulation for ink jet printing has good optical density and image quality thereby improving the overall quality of the printed image.

### SUMMARY OF THE INVENTION

The present teachings provide for an ink jet recording paper that incorporates precipitated calcium carbonate (PCC).

The PCC is prepared by first admixing calcium oxide with water to produce calcium hydroxide slurry. Citric acid is admixed with the calcium hydroxide slurry and the slurry carbonated to produce PCC slurry. The PCC slurry is then dewatered producing a high solids PCC composition. The high solids PCC composition is treated with an amphoteric and/or anionic dispersant followed by comminuting the PCC composition. Optionally, citric acid may be added prior to, in conjunction with, or subsequent to the dispersant being added to the high solids PCC composition.

### DETAILED DESCRIPTION OF THE INVENTION

An ink jet recording media has been produced that provides full color ink jet print quality. The selection of precipitated calcium carbonate (PCC) particle size, surface area, surface chemistry, and degree of aggregation allows each ink jet print characteristic to be individually adjusted and optimized.

The PCC pigment for ink jet recording media of the present teachings are produced wherein calcium oxide is admixed with water to produce a calcium hydroxide slurry. The calcium hydroxide slurry is admixed with citric acid wherein the citric acid can be supplied in solution or solid form. Carbon dioxide is introduced into the calcium hydroxide slurry until the hydroxide slurry is substantially converted to precipitated calcium carbonate (PCC). The resulting PCC is screened and dewatered producing a high solids PCC composition. An amphoteric or anionic dispersant is added to the high solids PCC composition and comminuted to produce a milled PCC pigment for use in ink jet coating formulations.

PCC Preparation

Admix calcium oxide with water to produce a calcium hydroxide slurry. Adjust the calcium hydroxide slurry temperature to from about 10 degrees Celsius to about 30 degrees Celsius. Admix citric acid to the calcium hydroxide slurry at a concentration of from about 0.25 percent by weight to about 1.5 percent by weight calcium carbonate produced. Add carbon dioxide to the calcium hydroxide slurry until the calcium hydroxide slurry is substantially converted to precipitated calcium carbonate (PCC) slurry. Conversion can take anywhere from about 30 minutes to about 90 minutes. Phosphoric acid is added to the PCC slurry at a concentration of from about 0.1 percent by weight PCC to about 0.8 percent by weight PCC to maintain the surface area of the PCC product. The PCC slurry is screened and dewatered to produce a high solids PCC composition of from about 25 percent to about 65 percent by weight PCC solids. The high solids PCC composition is admixed with from about 1.0 percent active dispersant by weight PCC to about 5.0 percent active dispersant by weight PCC of an amphoteric and/or anionic dispersant prior to being milled and/or comminuted.

To obtain the desired application viscosity, the dispersant level may exceed upwards of from about 8.0 percent active dispersant by weight PCC to about 10.0 percent active dispersant by weight PCC. Additionally, various surfactants which are known in the art such as to include but not limited to 2-amino-2-methyl-1-propanol, octylphenolpolyethoxylate, and/or polyvinyl alcohol may be added to the dewatered high solids PCC composition to facilitate the dispersion process and obtain the desired rheology.

The PCC slurry produced according to the present teachings has a specific surface area of from about 40 meters squared per gram (m²/g) to about 70 m²/g and a solids concentration of from about 10 percent by weight to about 15 percent by weight PCC. The PCC slurry is then screened, dewatered and comminuted in the presence of a dispersant to obtain the high solids PCC composition having the characteristics of the present invention's high quality, low cost ink jet recording media. A surfactant can optionally be added prior to, simultaneously, or subsequent to the dispersant being added.

Dewatering can be carried out using technology known in the art to include, but not limited to, centrifugation, filter press such as plate and frame press, Larox press, Andritz press, belt press, tube press, vacuum, and/or other known dewatering technology.

Comminution of the PCC may be carried out in either a wet or dry milling process using technology known in the art to include, but not limited to, a conventional ball mill, jet mill, micro mill, Cowles type dispersion mixer, kady mill, impingement type mill, sand and/or media mill. Comminution can be carried out by introducing concentrated slurry of PCC into a media mill containing glass media of a size from about 0.7 mm to about 0.9 mm. The media mill is equipped with mechanical agitation, and the resulting weight percent solids of the PCC slurry is from about 25 to about 65 percent based on the total weight of the PCC and the water. When media milling is performed on the PCC of the present teachings, the specific surface area is from about 40 meters squared per gram (m²/g) to about 70 m²/g. Milling is performed on the PCC of the present teachings to a target Brookfield viscosity of from about 200 centipoise (cps) to about 2000 cps at 100 revolutions per minute (rpm) using the appropriate spindle.

The Citric Acid

The citric acid of the present teachings can be any known citric acid. Citric acid is admixed with the calcium hydroxide slurry at levels from about 0.25 percent to about 1.5 percent by weight, based on the weight of the PCC produced. Citric acid can be used in solution and/or solid form.

The Amphoteric Dispersant

The amphoteric dispersant of the present teachings can be from sodium salts of co-polymers of acrylic acid and diallyldimethylammonium chloride (DMDAAC). There may also be sodium salts of co-polymers of acrylic acid and methyl chloride quaternaryamine of dimethylaminoethylacrylate (DMAEA:quatemaryamine). There may also be an acrylic acid (AA) and DMDAAC:quaternaryamine copolymer. The amphoteric dispersants useful in the present teachings have an average molecular weight, as ranging from about 2000 to about 10000 or from about 2000 to about 6000. This is the molecular weight as determined by viscosity of the polymer in solution at a specific temperature which gives an average molecular weight of the molecular chains in the polymer independent of the specific chain length. The value falls between weight average and number average molecular weight.

Amphoteric dispersants can be admixed with the PCC slurry in a range of from about 1.0 percent active dispersant by weight PCC to about 5.0 percent active dispersant by weight PCC or from about 2.0 percent active dispersant by weight PCC to about 3.5 percent active dispersant by weight PCC.

The Anionic Dispersant

The anionic dispersants useful in the present teachings can be sodium polyacrylates having a molecular weight ranging of from about 2000 to about 10000 or from about 2000 to about 6000. This is the molecular weight as determined by viscosity of the polymer in solution at a specific temperature which gives an average molecular weight of the molecular chains in the polymer independent of the specific chain length. The value falls between weight average and number average molecular weight. Examples of commercially available anionic dispersants that are useful in the present teachings are: Colloids 207, 211, 220 and 260 from Kemira Chemicals, Inc. 245 Town Park Drive, Suite 200, Kennesaw, Ga. 30144; Acumer 9300 from Rohm & Haas Company 100 Independence Mall West, Philadelphia, Pa. 19106-2399; and Sokalan HP-80 from BASF Corporation Function Polymers, 11501 Steele Creek Rd., Charlotte, N.C. Also, the anionic dispersant can be a copolymer of acrylic and maleic acids or a carboxymethylcellulose.

The anionic dispersant is admixed with the PCC slurry in a range of from about 1.0 percent active dispersant by weight PCC to about 5.0 percent active dispersant by weight PCC or from about 2.0 percent active dispersant by weight PCC to about 3.5 percent active dispersant by weight PCC. Optionally, surfactants can be added to the high solids PCC composition.

In the present teachings, PCC screening starts after the calcium hydroxide is substantially converted to calcium carbonate. This is indicated when the conductivity of the slurry reaches a minimum, which is typically at a pH of from about 7 to about 8.

Ink jet recording papers incorporating the PCC of the present teachings have been prepared. The following is a summary of the procedures and testing methods used. Once the PCC of the present teachings are produced, the entire testing process can be categorized into four areas; pigment preparation, formulation with binder, paper coating and processing, and testing. Specific details for each of these procedures are given below.

Pigment Preparation

Pigments to be tested are typically in the form of concentrated slurry or a filter cake having a solids concentration of from about 25 percent to about 65 percent. Samples in the form of a slurry are concentrated to the desired solids by vacuum and/or similar filtration. In addition, various surfactants or dispersants may be added to facilitate concentrating the slurry. In some instances, such as with a media milled PCC having a specific surface area of about 40 m²/g to about 70 m²/g, the slurry solids are not further altered in order to duplicate trial conditions. A target coating formulation solids is set and the pigment is diluted, if necessary, with water and thoroughly mixed. The pigment is characterized by specific surface area (Flowsorb), solids concentration, surface charge and viscosity (Brookfield).

The surface area of the product was obtained by using a Micromeritics Flowsorb II 2300, which employs BET theory with nitrogen as the absorbing gas. Surface charge of the product was determined using Doppler Electrophoretic Light Scattering Analysis (DELSA). Viscosity was determined using a Brookfield Viscometer as described above.

Coating Formulation

Typical binders include starch, polyvinyl alcohol (PVOH), polyvinyl acetate and/or latex and can be used as the sole binder and/or blended as is known in the art. When a starch is used as a binder, the dry starch is dispersed in water at from about 10 to about 35 percent solids, and then cooked in an automated laboratory cooker at about 200 degrees Celsius for about 50 minutes to about 190 minutes. The resulting viscous starch slurry is combined with the pigment, which has been appropriately prepared to attain the target formulation solids, and mixed thoroughly on a mill such as those that can be obtained through Premier Mill SPX Process Equipment, Delavan, Wis., and/or similar mill with a Cowles type open impeller and/or similar blade. The formulation is mixed for about 5 minutes until a homogenous and/or uniform slurry is obtained. The resulting formulation is characterized by Brookfield viscosity (10, 20, 50 and 100 rpm) and solids concentration.

Dry polyvinyl alcohol (PVOH) is prepared in a manner similar to that used for starch. The PVOH is hydrated at about 200 degrees Celsius in a laboratory cooker for from about 50 minutes to about 190 minutes at about from 10 percent solids to about 25 percent solids. For the latex binder (50 percent solids), liquid PVOH and/or polyvinyl acetate, no preparation is necessary before testing. The formulation of these binders with the pigment is the same as with the starch.

Formulation solids for the tests were in the range of from about 20 percent solids by weight to about 50 percent solids by weight, with a typical coating formulation having from about 30 percent solids by weight to about 45 percent solids by weight.

Binders

Examples of binders useful for coating compositions for ink jet recording paper are those heretofore conventionally used in the art, and include but are not limited to, polyvinyl alcohol (PVOH) and/or derivatives thereof, oxidized starch, esterified starch, dextrin and/or like starches, carboxymethylcellulose, hydroxyethylcellulose and/or like cellulose derivatives, casein, gelatin, soybean protein, maleic anhydride resin, lattices of usual styrenebutadiene copolymer, methyl methacrylate-butadiene copolymer and/or like conjugated diene polymers and/or copolymers, and/or lattices of acrylate and/or methacrylate polymers and/or copolymers and/or like acrylic polymers, and/or latex. When required, the coating composition may have further incorporated therein in an amount conventionally used in the art of conventional pigment dispersants, tackifiers, flowability modifiers, defoaming agents, foaming inhibitors, release agents, coloring agents, and/or the like.

Paper Coating

An unsized paper base stock of about 81.3 grams per meter squared (g/m²) to about 83.0 g/m² basis weight is used in the tests. The paper is cut into 12 inch×17 inch sheets and secured to the CSD Drawdown Apparatus, manufactured by CSD Tech International, Inc., of Oldsmar, Fla., which consists of a glass plate (12 inch×17 inch) mounted on a metal base with a spring clip at the top. A coating formulation is applied with a CSD drawdown rod by placing the rod of choice, which depends on target coat weight, at the top of the paper, adding a uniform line of coating formulation across the top of the paper, below the rod, and coating the paper by pulling the drawdown rod from top to bottom using light pressure and a constant, steady rate for about 2 seconds.

The coat weight is determined by the stainless steel drawdown rods, which are specifically grooved to deliver a predetermined coating volume to the paper surface. Rods with fewer grooves deliver a heavier coat weight, since the spaces between the grooves is wider. In turn, rods with a greater number of more tightly spaced grooves produce lighter coat weights. Typical coat weights are from about 2 grams per meter squared (g/m²) to about 12 g/m².

After the coating formulation has been applied to the paper base stock, the base stock is immediately dried with a hand held heat gun for from about 30 seconds to about 60 seconds. The coated paper is conditioned in a constant temperature and humidity environment over a period of about 24 hours. The conditioned papers are then cut into 8 ½×11 inch sheets for testing.

It should be understood that the coating formulation of the present teachings can be applied to paper base stock using any paper coater known in the art such as, but not limited to, a rod coater, blade coater, airknife, metered size press, size press, curtain coater and/or cast coater.

Paper Testing

Ink jet print quality criteria have been established by Hewlett Packard Corporation (“HP”). Therefore, unless otherwise stated HP test methods were used to determine the following print characteristics.

Optical density is a measure of the reflection density of an image. A specific test pattern is printed onto the paper, and the optical densities of pure black, composite black, cyan, magenta, and yellow inks are measured using a reflection densitometer (Macbeth RD918). The resulting optical densities are compared to HP specifications.

Ink spreading and feathering can both decrease the quality of ink jet print. Ink spreading is defined as the growth and/or widening of printed areas. Feathering is the wicking of ink, which results in fuzzy images. This is measured by analyzing a specific portion of the same, printed pattern used for optical density measurements. The specific portion is evaluated for ink area spreading and ink perimeter feathering. The resulting, digitized pattern is quantitatively compared to a commercial premium ink jet paper. The HP test method for ink spreading and feathering was not used in these tests, since the HP test is subjective rather than quantitative.

Ink dry time is a measure of the rate of ink absorption into a sheet of paper. A specific test pattern is printed, the image is blotted, and the resulting optical density of the transferred black ink is measured. The results are fitted to a decaying exponential model from HP, and the ink dry time is calculated. The final dry times are compared to criteria set by HP.

Waterfastness is a measure of the amount of colorant transferred from a printed area to an unprinted area when water is applied. The waterfastness test pattern is printed onto the paper, 250 microliter (μl) of water is applied across the print, and allowed to run over the printed area and adjacent unprinted area. The optical density of the transferred black ink on the unprinted areas is measured. Resulting optical densities are compared to HP standards.

In the brightness test, the coated paper is tested for TAPPI brightness using the Technidyne S-4 brightness meters. Results are compared to the uncoated base stock.

Other Ink Jet Media

The present teachings also relate to the use of the PCC pigment in ink jet coating formulations that are particularly useful in paperboard, transparency, fabric, and tee-shirt iron on. The PCC for use in these applications is prepared according to the process of the present teachings for the preparation of the ink jet coating formulation.

### EXAMPLES

The following non-limiting examples are merely illustrative embodiments of the present teachings and are not to be construed as limiting the invention, the scope of which is defined by the appended claims.

### Example 1

Calcium oxide (CaO) and water were admixed in a lime slaker producing a calcium hydroxide (Ca(OH)₂) slurry wherein at least 90 percent of the CaO is converted to Ca(OH)₂ as measured by methyl orange (MO) titration.

The calcium hydroxide slurry was diluted to from about 10 percent to about 15 percent solids by weight of calcium carbonate and transferred to a reaction vessel and about 0.5 percent by weight calcium hydroxide citric acid was added to the calcium hydroxide slurry. The temperature was adjusted to 15 degrees Celsius. Carbon dioxide was added until conductivity reached a minimum (less than 75 minutes), indicating the calcium hydroxide slurry had been substantially converted to calcium carbonate slurry. Carbonation was continued for an additional 5 minutes before the carbon dioxide was shut off. Phosphoric acid was added at a concentration of about 0.33 percent by weight calcium carbonate and calcium carbonate agitated for an additional 5 minutes producing about a 15 percent solids precipitated calcium carbonate (PCC) slurry with a pH of about 7.5 to about 8.5.

The PCC slurry was screened at 325 mesh and dewatered by centrifugation producing a high solids PCC composition. The PCC composition was treated with dispersant and then processed using a Kady mill to produce a dispersed PCC composition that was from about 40 percent solids to about 50 percent solids concentration. The composition had a Brookfield viscosity of from about 500 centipoise (cps) to about 1000 cps as measured at 100 rpm with the appropriate spindle. The PCC particles had a specific surface area of from about 60 m²/g to about 70 m²/g and a surface charge of from about negative (−)30 millivolt (mV) to about positive (+)5 mV dependant upon the dispersant chemistry employed.

### Example 2

Dispersed precipitated calcium carbonate (PCC) was produced in the same manner as that described in Example 1. The dispersed PCC was evaluated in five ink jet coating formulations containing one anionic (Sample 202) and four amphoteric (Samples 205, 206, 209 and 210) dispersants respectively, and compared with an uncoated paper base stock. Each PCC composition was formulated into an ink jet coating with 7 parts polyvinyl alcohol per 100 parts PCC. Paper samples were coated with from about 6 g/m² to about 9 g/m² of the coating formulation using the drawdown technique described above. After drying, hand drawdowns were tested for optical density and color bleed evaluations. The results of these tests are given in Table 1.

TABLE 1

| | Ink Spreading | Black | Cyan | Magenta | Yellow |
|---|---|---|---|---|---|
| | and | (optical | (optical | (optical | (optical |
| Sample | Feathering | density) | density) | density) | density) |
| 202 | 101.29 | 1.42 | 1.61 | 1.46 | 1.30 |
| 205 | 100.87 | 1.51 | 1.49 | 1.31 | 1.22 |
| 206 | 100.47 | 1.53 | 1.43 | 1.38 | 1.25 |
| 209 | 100.81 | 1.45 | 1.46 | 1.34 | 1.12 |
| 210 | 102.24 | 1.43 | 1.49 | 1.35 | 1.16 |
| Uncoated | 102.11 | 1.16 | 1.10 | 1.09 | 1.04 |
| Base Stock | | | | | |

The results indicate that the dispersant chemistry of the present teachings provide for lower ink spreading and feathering (lower numbers are better) while maintaining superior print density to that of the uncoated base stock.

### Example 3

Dispersed precipitated calcium carbonate (PCC) was produced in the same manner as that described in Example 1. The dispersed PCC was formulated into an ink jet coating containing starch ( Sample 229), polyvinyl alcohol (Sample 209), and blends of polyvinyl alcohol and starch (Sample 233). Paper samples were coated with from about 5 g/m² to about 7 g/m² of the coating formulation. After drying, hand drawdowns were tested for optical density and color bleed evaluations. The results of these tests are given in Table 2.

TABLE 2

| | Ink Spreading | Black | Cyan | Magenta | Yellow |
|---|---|---|---|---|---|
| | and | (optical | (optical | (optical | (optical |
| Sample | Feathering | density) | density) | density) | density) |
| 229 | 103.67 | 1.48 | 1.49 | 1.40 | 1.37 |
| 233 | 102.90 | 1.42 | 1.38 | 1.28 | 1.18 |
| 209 | 100.81 | 1.45 | 1.46 | 1.34 | 1.12 |
| Uncoated | 102.10 | 1.16 | 1.10 | 1.09 | 1.04 |
| Base Stock | | | | | |

The results indicate the PCC of the present invention can be used with various binders providing for superior optical density to that of the uncoated base stock, as well as provides equal or better ink spreading and feathering results to that of the uncoated base stock.

While it is apparent that the teachings disclosed herein is well calculated to fulfill the objects stated above, it will be appreciated that numerous modifications and embodiments may be devised by those skilled in the art. Therefore, it is intended that the appended claims cover all such modifications and embodiments that fall within the scope of the present invention.

We claim:

1. A process for making a precipitated calcium carbonate for ink jet recording paper comprising:
a) admixing calcium oxide with water to produce a calcium hydroxide slurry;
b) admixing citric acid with the calcium hydroxide slurry;
c) introducing carbon dioxide to the calcium hydroxide slurry to produce a precipitated calcium carbonate slurry;
d) admixing phosphoric acid to the precipitated calcium carbonate slurry;
e) screening and dewatering the calcium carbonate slurry; and
f) comminuting the precipitated calcium carbonate in the presence of an amphoteric and/or anionic dispersant to produce a precipitated calcium carbonate (PCC) product of from about 25 percent by weight to about 65 percent by weight concentration solids, a viscosity of from about 200 centipoise to about 2000 centipoise, and a BET specific surface area of from about 40 meters squared per gram (m²/g) to about 70 m²/g.

2. A process for making a precipitated calcium carbonate for ink jet paper according to claim 1 wherein citric acid is added to the calcium hydroxide slurry in an amount of from about 0.25 percent to about 1.5 percent by weight PCC.

3. A process for making a precipitated calcium carbonate for ink jet paper according to claim 1 wherein phosphoric acid is added to the precipitated calcium carbonate slurry in an amount of from about 0.1 percent to about 0.8 percent by weight PCC.

4. A process for making a precipitated calcium carbonate for ink jet paper according to claim 1 wherein the dispersant has a molecular weight ranging from about 2000 to about 10000

5. A process for making a precipitated calcium carbonate for ink jet paper according to claim 1 wherein the dispersant has a molecular weight of from about 2000 to about 6000.

6. A process for making a precipitated calcium carbonate for ink jet paper according to claim 1 wherein the PCC is comminuted in the presence of an amphoteric dispersant.

7. A process for making a precipitated calcium carbonate for ink jet paper according to claim 6 wherein the amphoteric dispersant is chosen from sodium salts of co-polymers of acrylic acid and diallyldimethylammonium chloride (DMDAAC); sodium salts of co-polymers of acrylic acid and methyl chloride quatemaryamine of dimethylaminoethylacrylate (DMAEA: quatemaryamine); an acrylic acid (AA) and a DMDAAC:quatemaryamine copolymer.

8. A process for making a precipitated calcium carbonate for ink jet paper according to claim 1 wherein the PCC is comminuted in the presence of an anionic dispersant.

9. A process for making a precipitated calcium carbonate for ink jet paper according to claim 8 wherein the anionic dispersant is chosen from sodium polyacrylates, copolymers of acrylic and maleic acid, and carboxymethylcellulose.

10. The process for making a precipitated calcium carbonate for ink jet paper according to claim 1 wherein citric acid may be added prior to or in conjunction with milling the precipitated calcium carbonate.

11. A coating formulation for ink jet recording paper comprising:
admixing precipitated calcium carbonate having a solids concentration of from about 25 percent by weight to about 65 percent by weight, a viscosity of from about 500 centipoise to about 1000 centipoise, a specific surface area of from about 40 m²/g to about 70 m²/g, and a surface charge of from about negative (−)30 millivolt (mV) to about positive (+)5 mV with a binder.

12. A coating formulation for ink jet recording paper according to claim 11 wherein the binder can be polyvinyl alcohol (PVOH), oxidized starch, esterified starch, dextrin and/or like starches, carboxymethylcellulose, hydroxyethylcellulose, casein, gelatin, soybean protein, maleic anhydride resin, lattices of usual styrenebutadiene copolymer, methyl methacrylate-butadiene copolymer and/or copolymers, and/or lattices of acrylate and/or methacrylate polymers and/or copolymers and/or latex and the binders can be used alone or in any combination with each other.

13. A coating formulation for ink jet recording paper according to claim 10 further comprising: dispersants, tackifiers, flowability modifiers, defoaming agents, foaming inhibitors, release agents, coloring agents, and/or the like.

14. An ink jet recording paper comprising a paper base stock, having a coating comprising: a comminuted precipitated calcium carbonate pigment, the pigment being produced by milling a precipitated calcium carbonate in the presence of an amphoteric and/or anionic dispersant wherein the comminuted precipitated calcium carbonate has a solids concentration of from about 25 percent by weight to about 65 percent by weight, a viscosity of from about 200 centipoise to about 2000 centipoise, and a specific surface area of from about 40 m²/g to about 70 m²/g.

15. A method for producing an ink jet recording paper comprising:
a) admixing calcium oxide with water to produce a calcium hydroxide slurry;
b) introducing carbon dioxide to the calcium hydroxide slurry to produce a precipitated calcium carbonate slurry;
c) admixing phosphoric acid to the precipitated calcium carbonate slurry;
d) screening and dewatering the calcium carbonate slurry;
e) comminuting the precipitated calcium carbonate in the presence of an amphoteric and/or anionic dispersant to produce a precipitated calcium carbonate product; and,
f) coating at least one side of a paper base stock with a coating formulation comprising the comminuted precipitated calcium carbonate and binder to form the ink jet recording paper.

16. A process for making a precipitated calcium carbonate according to claim 1 wherein the precipitated calcium carbonate is used in ink jet coating formulations for paperboard, transparency, fabric, and tee-shirt iron-ons.
